(19) United States
(12) Patent Application Publication
(10) Pub. No.: US 2022/0044166 A1
(43) Pub. Date: Feb. 10, 2022

(54) AUTOMATIC INITIATION OF FOLLOW-ON TRANSACTION FROM A PRIMARY TRANSACTION WITH NESTED APPLICATION DISTRIBUTION

(71) Applicant: Gametime, San Francisco, CA (US)

(72) Inventor: Bradley Griffith, Bellevue, WA (US)

(73) Assignee: Gametime, San Francisco, CA (US)

(21) Appl. No.: 17/509,999

(22) Filed: Oct. 25, 2021

Related U.S. Application Data
(63) Continuation of application No. 15/632,356, filed on Jun. 25, 2017.
(60) Provisional application No. 62/402,960, filed on Sep. 30, 2016.

(51) Int. Cl. G06Q 10/02; G06Q 20/12; G06Q 40/04; G07F 17/42; G06Q 20/32; G06F 21/60; G06Q 30/06

(52) U.S. Cl. CPC G06Q 10/02; G06Q 20/12; G06Q 40/04; G06Q 30/0643; G06Q 20/322; G06F 21/606; G07F 17/42

(57) ABSTRACT

A method of default sharing an electronic ticket purchase comprises receiving at least one electronic ticket from an electronic ticket vending system at an application interface in response to receiving an electronic ticket purchasing request from a user account associated with the application interface on the electronic ticket vending system; operating default sharing logic to receive the at least one electronic ticket from the application interface at a user interface and display an electronic ticket sharing interface to select a contact entry from stored contacts in memory to for the at least one electronic ticket; transmitting an electronic ticket notification by way of a network interface to a second client device in response to detecting a selected contact entry through the electronic ticket sharing interface; and transmitting a ticket install notification to an electronic ticket assignment controlled memory data structure to associate the at least one electronic ticket with the second client device in response to installation of the at least one electronic ticket on the second client device.

### CROSS-REFERENCE TO RELATED APPLICATIONS

This application claims benefit under 35 U.S.C. 119 to U.S. application Ser. No. 62/402,960, filed on Sep. 30, 2016, which is incorporated herein by reference in its entirety.

### BACKGROUND

Ticket distribution services often rely on ticket purchasers to perform the individual distribution of each ticket in a set to intended attendee. Some systems provide the ticket purchaser with a set of tickets in a file that can be duplicated and shared typically by email. While the current system offers a significant amount of flexibility for swapping tickets, it can create validation and accounting issue in larger groups, especially if the group splits and attempts to enter the event at separate times and/or locations. Although some systems allow a ticket purchaser to assign tickets to individual attendees, these systems require the ticker purchaser to enter each attendees contact information manually. As such, current system fail to offer a solution to conveniently and effectively assign and distribute tickets to a group of attendees.

FIG. 1 illustrates an embodiment of a system environment for a method of default sharing 100. The system environment for a method of default sharing 100 comprises a network 104 (e.g., LAN, WAN, WWW), a database 106 (e.g., Oracle, DB2, MySQL, PostgreSQL, SQLite, SQL server, Sybase, etc.), server 102 (e.g., LAMP, Oracle, Microsoft) and client device 112 and client devices 108 (e.g., desktop PCs, mobile phones, laptops, tablets, wearable computers, or other computing devices). The network may comprise devices interconnected in ways known the art to effect communications between the various components (e.g., routers, hubs, servers, gateways, network bridges, modems, wireless access points, networking cables, line drivers, switches, and repeaters, and also include hybrid network devices such as multilayer switches, protocol converters, bridge routers, proxy servers, firewalls, network address translators, multiplexers, network interface controllers, wireless network interface controllers, ISDN terminal adapters, WAN, LAN, WWW, etc.) The client devices are capable of connecting to network 104 and communicating with server 102, such as described herein.

In various embodiments, additional infrastructure (e.g., short message service centers, cell sites, routers, gateways, firewalls, and the like), as well as additional devices may be present. Further, in some embodiments, the functions described as being provided by some or all of server 102 and client devices 108 and client device 112 may be implemented via various combinations of physical and/or logical devices. However, it is not necessary to show such infrastructure and implementation details in FIG. 1 in order to describe an illustrative embodiment.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a system environment for a method of default sharing 100.

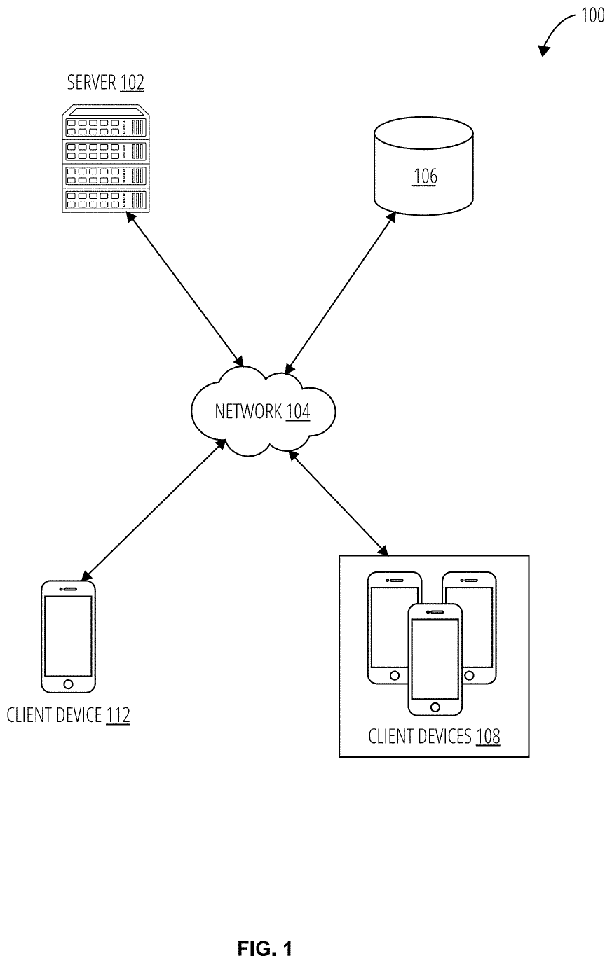

FIG. 2 illustrates an embodiment of a default sharing system 200.

FIG. 3 illustrates an embodiment of a default sharing process 300.

FIG. 4 illustrates an embodiment of an application interface operating method 400.

FIG. 5 illustrates an embodiment of a user interface operating method 500.

FIG. 6 illustrates an embodiment of an electronic ticket sharing interface operating method 600.

FIG. 7 illustrates a system 700 in accordance with one embodiment.

FIG. 8 illustrate an embodiment of electronic ticket sharing interface 800 displaying a loading screen following ticket acquisition.

FIG. 9 illustrates an embodiment of electronic ticket sharing interface 900 displaying options for selecting a contact entry from the stored contacts.

FIG. 10 illustrates an embodiment of electronic ticket sharing interface 1000 displaying a confirmation message to the user before sending the electronic ticket notification to a selected contact entry.

FIG. 11 illustrates an embodiment of electronic ticket sharing interface 1100 displaying a confirmation message that the ticket has been accepted by the selected contact entry.

FIG. 12 illustrates an embodiment of electronic ticket sharing interface 1200 displaying assignment of the second ticket to the selected contact entry.

FIG. 13 illustrates an embodiment of user interface 1300 displaying an electronic ticket notification received by the selected contact entry.

FIG. 14 illustrates an embodiment of a user interface 1400 displaying a ticket installation option for the selected contact entry.

FIG. 15 illustrates an embodiment of a user interface 1500 displaying ticket assignment to the selected contact following ticket installation.

### DETAILED DESCRIPTION

A method of default sharing at electronic ticket purchase includes receiving at least one electronic ticket from an electronic ticket vending system at an application interface in response to receiving an electronic ticket purchasing request from a user account associated with the application interface on the electronic ticket vending system, operating default sharing logic, transmitting an electronic ticket notification by way of a network interface to a second client device in response to detecting a selected contact entry through the electronic ticket sharing interface, and transmitting a ticket install notification to the electronic ticket assignment controlled memory data structure to associate the at least one electronic ticket with the second client device in response to installation of the at least one electronic ticket on the second client device.

The default sharing logic may receive the at least one electronic ticket from the application interface at the user interface, and display an electronic ticket sharing interface to select a contact entry from stored contacts in memory for the at least one electronic ticket.

A ticket and at least one other electronic ticket may be received from the electronic ticket vending system. The default sharing logic may associate a ticket of the at least two electronic tickets to the user account in an electronic ticket assignment controlled memory data structure, receive the at least one other electronic ticket from the application interface at the user interface, and display the electronic ticket sharing interface to select a contact entry from the stored contacts in memory for the at least one other electronic ticket.

Transmission of the electronic ticket notification to the second client device may controlled by contact information associated with the selected contact entry. The at least one electronic ticket may be associated to the second client device through an existing user account in the electronic ticket assignment controlled memory data structure.

The at least one electronic ticket may be associated to the second client device through a new user account created in the electronic ticket assignment controlled memory data structure. At least one electronic ticket may be assigned to a purchasing user through operations of the application, by displaying an animation to link at least one other electronic ticket with a contact stored in memory through operation of a user interface, and transmitting a ticket installation notification to the selected contact, and repeating the animation for each additional ticket purchased by the purchasing user.

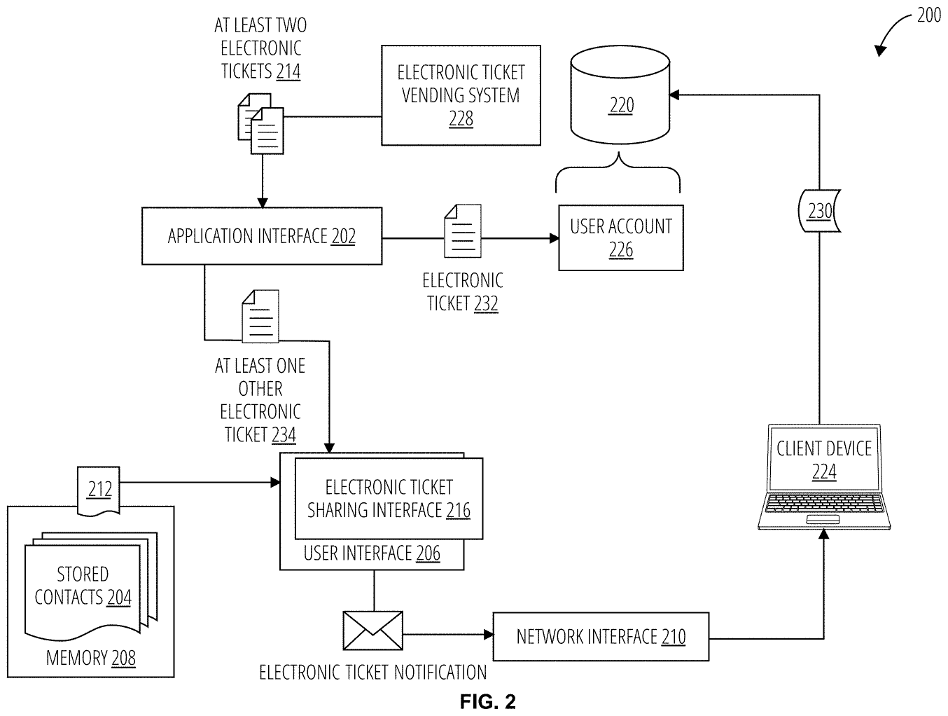

Referring to FIG. 2, the default sharing system 200 comprises an application interface 202, a user interface 206, a memory 208, a network interface 210, a ticket assignment database 220, an other client device 224, and an electronic ticket vending system 228.

The application interface 202 receives at least two electronic tickets 214 from the electronic ticket vending system 228. The application interface 202 sends a ticket 232 to a user account 226 to associate the ticket 232 with the user account 226. The application interface 202 may determine the ticket 232 by selecting: randomly, the ticket associated with a first or last seat if continuous, the ticket associated with the best view, the ticket with the highest price, the ticket with the best value, etc. The application interface 202 may be associated with the user account 226 and be utilized to operate the user account 226 to send a purchase request to the electronic ticket vending system 228. The application interface 202 may receive the at least two electronic tickets 214 from the electronic ticket vending system 228 in response to the purchase request. The application interface 202 may send at least one other electronic ticket 234 to the user interface 206.

The user interface 206 receives the at least one other electronic ticket 234 and displays an electronic ticket sharing interface 216. The user interface 206 may be configured to automatically display the electronic ticket sharing interface 216 in response to receiving the at least one other electronic ticket 234. The electronic ticket sharing interface 216 displays stored contacts 204, or a representation thereof, and is operated to select one of the stored contacts 204 to generate a selected contact entry 212. The electronic ticket sharing interface 216 may receive an input from the user interface 206, which may be operating on a client device, to select the selected contact entry 212. The electronic ticket sharing interface 216 generates a ticket notification 222 in response to the selected contact entry 212. The ticket notification 222 is sent to the other client device 224 through the network interface 210. The user interface 206 may also operate to prevent any of the at least one other electronic ticket 234 that have been shared with an other client device 224 from being shared with another other client device 224. The user interface 206 may also operate to receive an electronic ticket reclamation control to reclaim the at least one other electronic ticket 234 share with the other client device 224 by utilizing an electronic ticket reclamation notification sent to the other client device 224 via the network interface 210. The at least one other electronic ticket 234 is then disassociated with a user account 226 associated with the other client device 224. In some embodiments, the other client device 224 operates to receive a machine input and disassociates the at least one other electronic ticket 234 with the user account 226 of the at least one other electronic ticket 234. In response, the at least one other electronic ticket 234 may be re-shared utilizing the electronic ticket sharing interface 216.

The memory 208 comprises the stored contacts 204. A selected contact entry 212 is selected from the stored contacts 204 in the memory 208. The memory 208 may send information associated with the selected contact entry 212 to the electronic ticket sharing interface 216 to generate the ticket notification 222.

The ticket assignment database 220 comprises at least one user account 226. The user account 226 receives the ticket 232 from the application interface 202. The ticket assignment database 220 receives an install notification 230 from the other client device 224 following installation.

The other client device 224 receives the ticket notification 222 from the electronic ticket sharing interface 216 through the network interface 210. The other client device 224 sends the install notification 230 to the ticket assignment database 220. In some embodiments, the at least one other electronic ticket 234 received by the other client device 224 is prevented from being re-shared by the other client device 224.

The electronic ticket vending system 228 sends the at least two electronic tickets 214 to the application interface 202. The electronic ticket vending system 228 may receive the purchase request from the user account 226 and, in response, send the at least two electronic tickets 214 to the application interface 202.

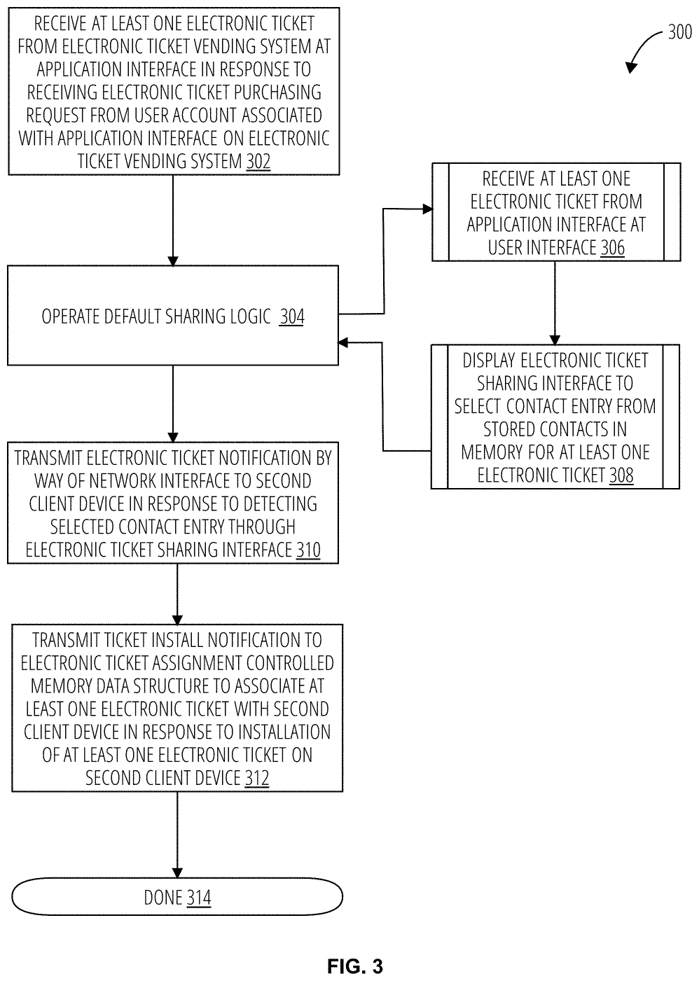

The default sharing system 200 may be implemented in accordance with the process described in FIG. 3.

Referring to FIG. 3, the default sharing process 300 receives at least one electronic ticket from the electronic ticket vending system at an application interface in response to receiving an electronic ticket purchase request from a user account associated with the application interface on the electronic ticket vending system (block 302). The default sharing logic is operated (block 304). The user interface receives at least one electronic ticket from the application interface as part of operation of the default sharing logic (subroutine block 306). An electronic ticket sharing interface is displayed to select a contact entry from the stored contacts in memory for that at least one electronic ticket (subroutine block 308). The ticket notification is transmitted by way of the network interface to the second client device in response to detecting the selected contact entry through electronic ticket sharing interface (block 310). The ticket install notification is transmitted to the electronic ticket assignment controlled memory data structure to associated the at least one electronic ticket with the second client device in response to the installation of the at least one electronic ticket on the second client device (block 312). The default sharing process 300 then ends (done block 314).

In another embodiment, the at least one electronic ticket comprises at least two electronic tickets comprising a ticket and at least one other electronic ticket. The default sharing process 300 performs additional operations including receiving from the electronic ticket vending system at the application interface in response to receiving the electronic ticket purchasing request from the user account associated with the application interface on the electronic ticket vending system. The default sharing logic then operates to further associate the ticket to the user account in the electronic ticket assignment controlled memory data structure, receive the at least one other electronic ticket from the application interface at the user interface, and display the electronic ticket sharing interface to select the contact entry from the stored contacts in the memory for the at least one other electronic ticket. The ticket install notification is transmitted to the electronic ticket assignment controlled memory data structure to associate the at least one other electronic ticket with the second client device in response to installation of the at least one other electronic ticket on the second client device.

The transmission of the electronic ticket notification to the second client device may be controlled by contact information associated with the selected contact entry. The at least one electronic ticket may be associated to the second client device through an existing user account in the electronic ticket assignment controlled memory data structure. The at least one electronic ticket may also be associated to the second client device through a new user account created in the electronic ticket assignment controlled memory data structure.

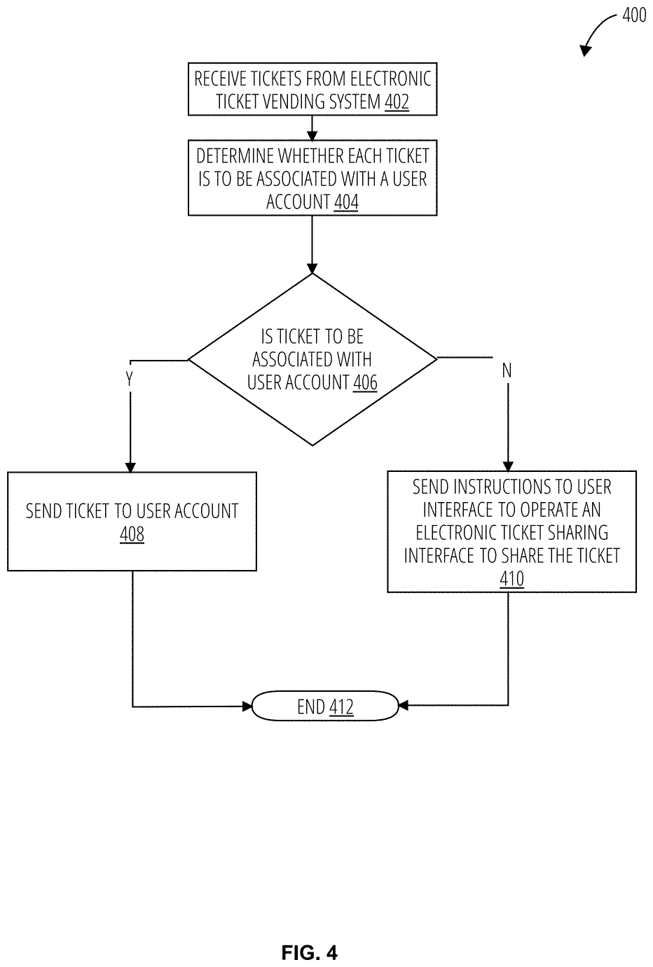

Referring to FIG. 4, the application interface operating method 400 receives tickets from an electronic ticket vending system (block 402). Whether each ticket is to be associated with a user account is determined (block 404). If a ticket is to be associated with a user account (decision block 406), the ticket is sent to the user account (block 408). If not, instructions are sent to a user interface to operate and display an electronic ticket sharing interface to share the ticket (block 410). The application interface operating method 400 then ends (done block 412).

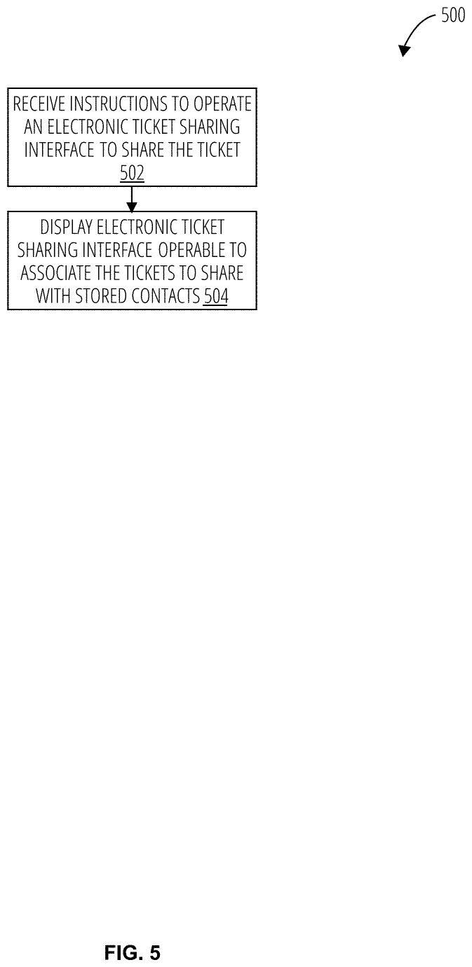

Referring to FIG. 5, the user interface operating method 500 receives instructions to operate an electronic ticket sharing interface to share the ticket (block 502). More than one ticket may be shared, and the tickets to be shared may be determined by the application interface. The electronic ticket sharing interface is displayed (block 504). The electronic ticket sharing interface may be operable to associates the tickets with stored contacts.

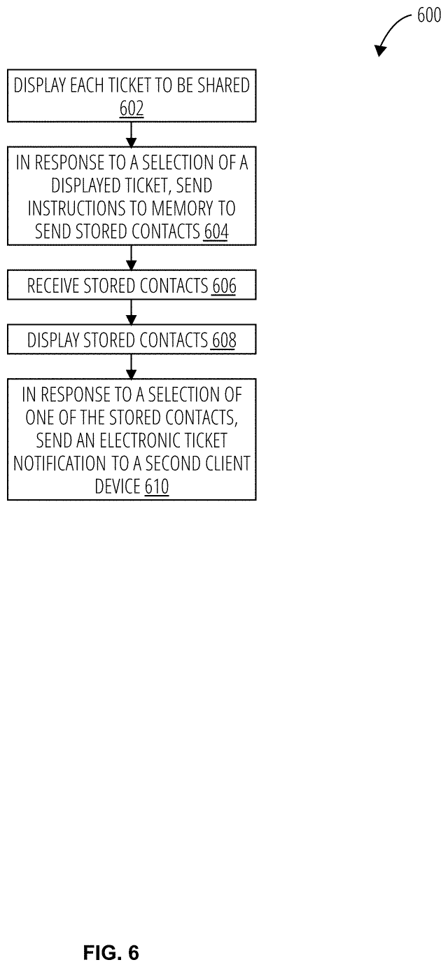

Referring to FIG. 6, the electronic ticket sharing interface operating method 600 comprises displaying each ticket to be shared (block 602). In response to a selection of a displayed ticket, instructions are sent to a memory to send stored contacts to the electronic ticket sharing interface (block 604). The stored contacts are received (block 606). The stored contacts are displayed (block 608). In response to a selection of one of the stored contacts, an electronic ticket notification is sent to a second client device (block 610). The second client device may be associated with the selected contact entry.

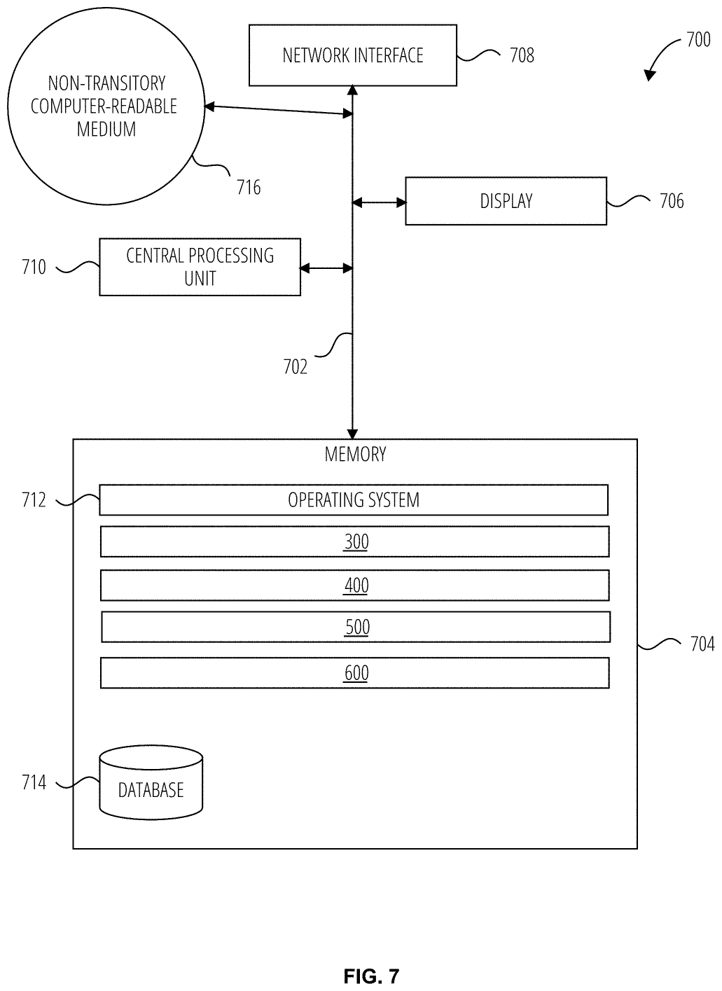

FIG. 7 illustrates several components of an exemplary system 700 in accordance with one embodiment. In various embodiments, system 700 may include a desktop PC, server, workstation, mobile phone, laptop, tablet, set-top box, appliance, or other computing device that is capable of performing operations such as those described herein. In some embodiments, system 700 may include many more components than those shown in FIG. 7. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In one embodiment, the system 700 is a mobile communication apparatus such as a mobile smartphone, including components well known in the art for such devices, such as at least one antenna, one or more integrated circuit processor, and a memory storing instructions that, when executed by the processor, configure the mobile communication device to receive at least one electronic ticket from an application interface to an electronic ticket vending system in response to an electronic ticket purchasing request applied to the electronic ticket vending system from a user account associated with the application interface. The mobile communication apparatus logic is configured to operate the default sharing logic to transfer the electronic ticket from the application interface to a user interface, and display an electronic ticket sharing interface to select a contact entry from stored contacts in a memory of the mobile communication apparatus. An electronic ticket notification is then transmitted over the antenna to a network interface to a second client device in response to detecting, through the electronic ticket sharing interface, a selected contact entry from the stored contacts, where the second client device is associated with the selected contact entry in the stored contacts.

In this embodiment, the mobile communication apparatus may be further configured to transmit a ticket install notification to an electronic ticket assignment controlled memory data structure to associate the at least one electronic ticket with the second client device, transmit an electronic ticket reclamation notification by way of the network interface to the second client device in response to detecting an electronic ticket reclamation control through the electronic ticket sharing interface, and de-associate the electronic ticket with/from the second client device in response to the electronic ticket reclamation notification.

Further in this embodiment, the mobile communication device may be configured to receive at least two electronic tickets comprising a ticket and at least one other electronic ticket received from the electronic ticket vending system for the user account associated with application interface on the electronic ticket vending system, and to operate the default sharing logic to associate a ticket of the at least two electronic tickets to the user account in the electronic ticket assignment controlled memory data structure, to receive the other electronic ticket (of the two) from the application interface at the user interface, and to display the electronic ticket sharing interface to select a contact entry from the stored contacts in the memory for the at least one other electronic ticket.

In various embodiments, system 700 may comprise one or more physical and/or logical devices that collectively provide the functionalities described herein. In some embodiments, system 700 may comprise one or more replicated and/or distributed physical or logical devices.

In some embodiments, system 700 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 700 includes a bus 702 interconnecting several components including a network interface 708, a display 706, a central processing unit 710, and a memory 704.

Memory 704 generally comprises a random access memory (“RAM”) and permanent non-transitory mass storage device, such as a hard disk drive or solid-state drive. Memory 704 stores an operating system 712 and default sharing process 300.

These and other software components may be loaded into memory 704 of system 700 using a drive mechanism (not shown) associated with a non-transitory computer-readable medium 716, such as a floppy disc, tape, DVD/CD-ROM drive, memory card, or the like.

Memory 704 also includes database 714. In some embodiments, system 700 may communicate with database 714 via network interface 708, a storage area network (“SAN”), a high-speed serial bus, and/or via the other suitable communication technology.

In some embodiments, database 714 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

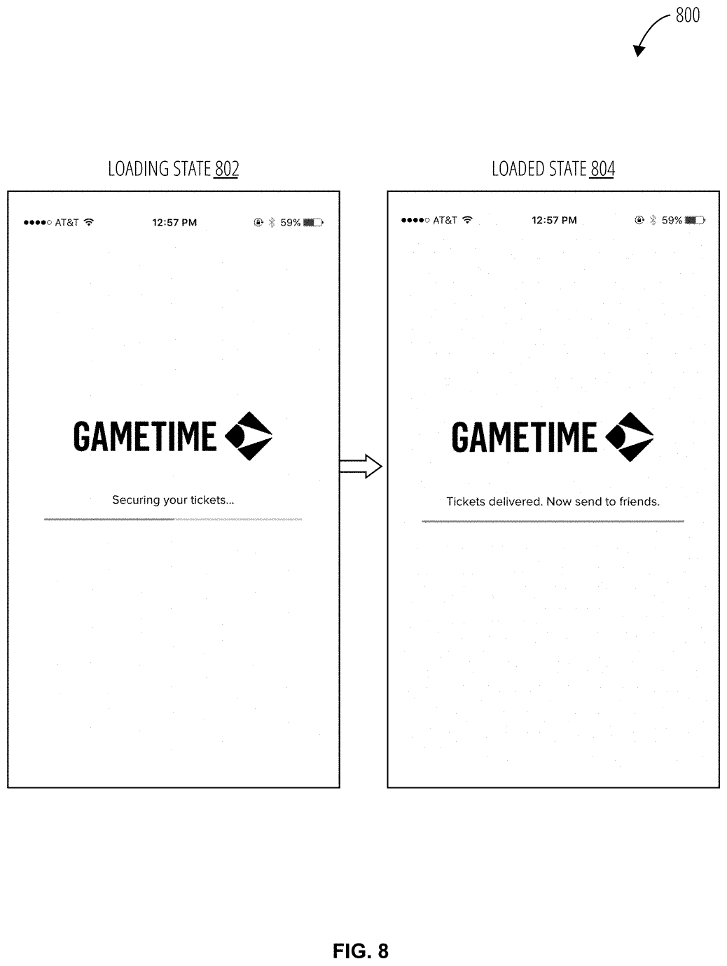

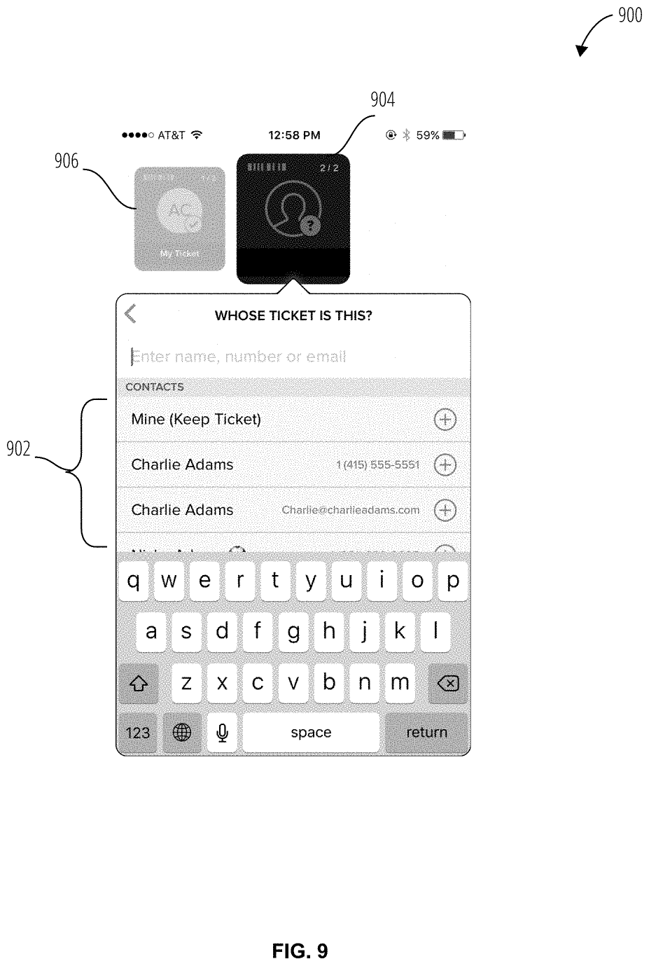

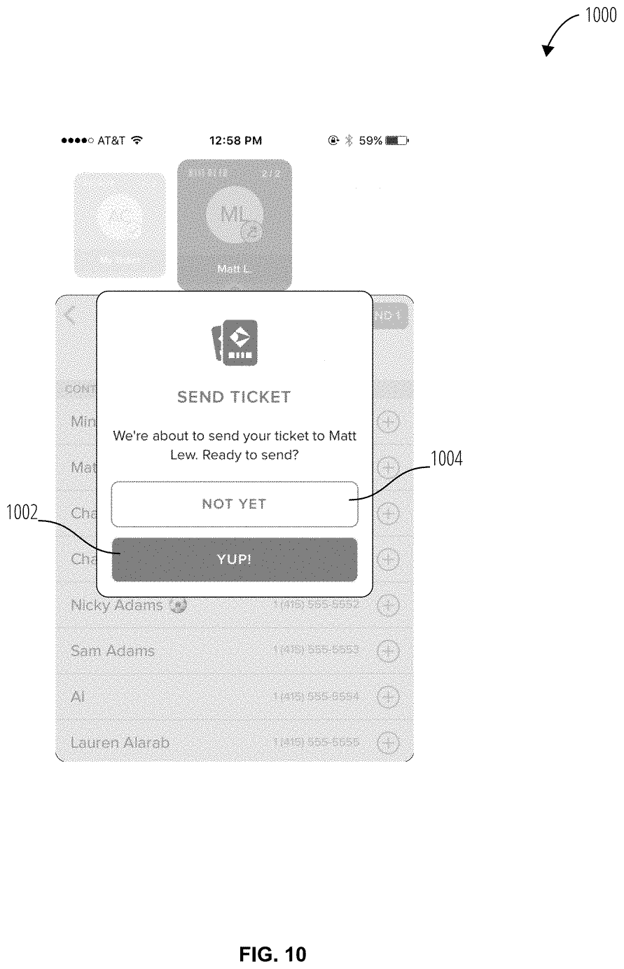

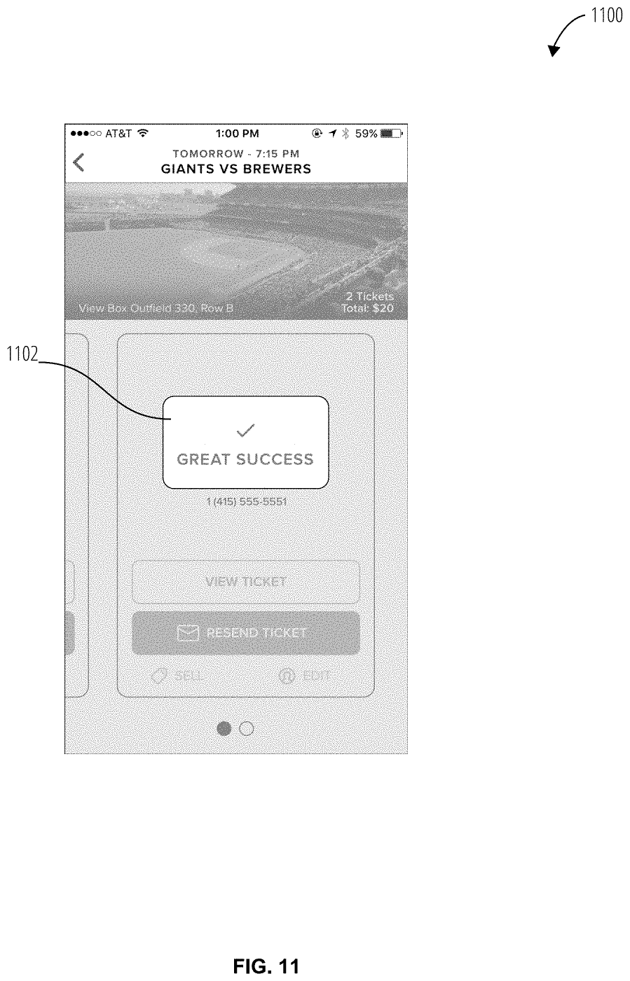

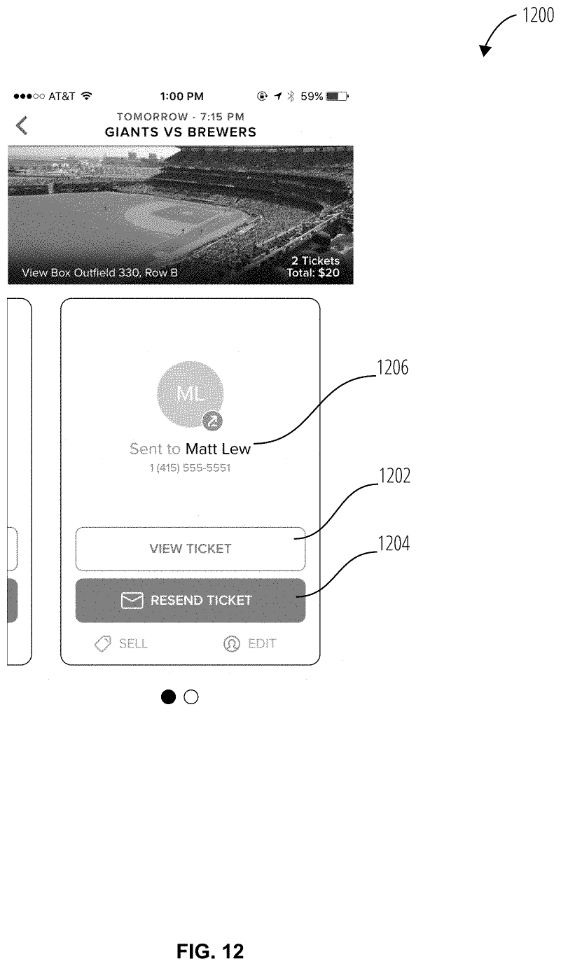

FIGS. 8-12 illustrate embodiments of an electronic ticket sharing interface, FIG. 8 illustrate an embodiment of electronic ticket sharing interface 800 displaying a loading screen following ticket acquisition. FIG. 9 illustrates an embodiment of electronic ticket sharing interface 900 displaying options for selecting a contact entry from the stored contacts. FIG. 10 illustrates an embodiment of electronic ticket sharing interface 1000 displaying a confirmation message to the user before sending the electronic ticket notification to a selected contact entry. FIG. 11 illustrates an embodiment of electronic ticket sharing interface 1100 displaying a confirmation message that the ticket has been accepted by the selected contact entry. FIG. 12 illustrates an embodiment of electronic ticket sharing interface 1200 displaying assignment of the second ticket to the selected contact entry.

Referring to FIG. 8, the electronic ticket sharing interface 800 comprises a loading state 802 and a loaded state 804. The loading state 802 may transition to the loaded state 804 when the ticket is received from the application interface by the electronic ticket sharing interface.

Referring to FIG. 9, the electronic ticket sharing interface 900 comprises a stored contacts 902, a stored contacts view selector 904, and a user account ticket view selector 906. The stored contacts 902 may be displayed on the electronic ticket sharing interface 900. Each of the stored contacts 902 may be operable to receive an input to associate the selected contact entry with a ticket. The stored contacts view selector 904 may receive an input to transition the electronic ticket sharing interface 900 to a view to display the stored contacts 902. The user account ticket view selector 906 may receive an input to transition the electronic ticket sharing interface 900 to a view to display tickets associated with the user account associated with the electronic ticket sharing interface 900.

Referring to FIG. 10, the electronic ticket sharing interface 1000 comprises a confirmation selector 1002 and a confirmation de-selector 1004. The confirmation selector 1002 receives an input to associate the previously selected contact entry with a ticket. The electronic ticket sharing interface 1000 then sends an electronic ticket notification to a second client device associated with the selected contact entry. The confirmation de-selector 1004 receives an input to transition the electronic ticket sharing interface 1000 to a state displaying stored contacts.

Referring to FIG. 11, the electronic ticket sharing interface 1100 comprises a confirmation message 1102. The electronic ticket sharing interface 1100 may display the confirmation message 1102 in response to a notification that a ticket has been accepted by the selected contact entry.

Referring to FIG. 12, the electronic ticket sharing interface 1200 comprises a ticket view selector 1202, an electronic ticket notification activator 1204, and a selected contact entry display 1206. The ticket view selector 1202 receives an input and, in response, transitions the electronic ticket sharing interface 1200 to display the ticket associated with the selected contact entry associated with the selected contact entry display 1206. The electronic ticket notification activator 1204 receives an input and, in response, sends an electronic ticket notification to the selected contact entry associated with the selected contact entry display 1206. The selected contact entry display 1206 displays contact information associated with the selected contact entry associated with the ticket being shared.

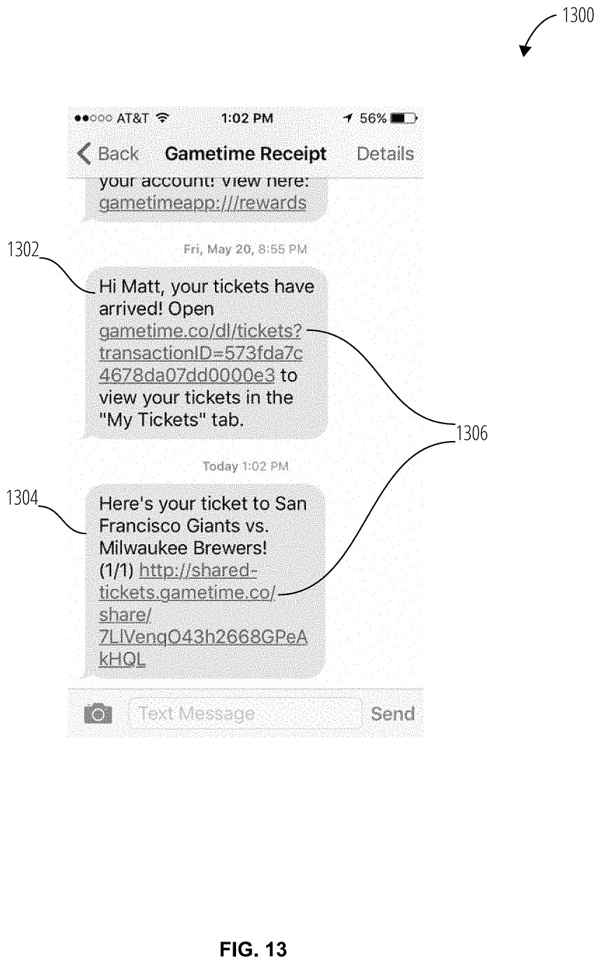

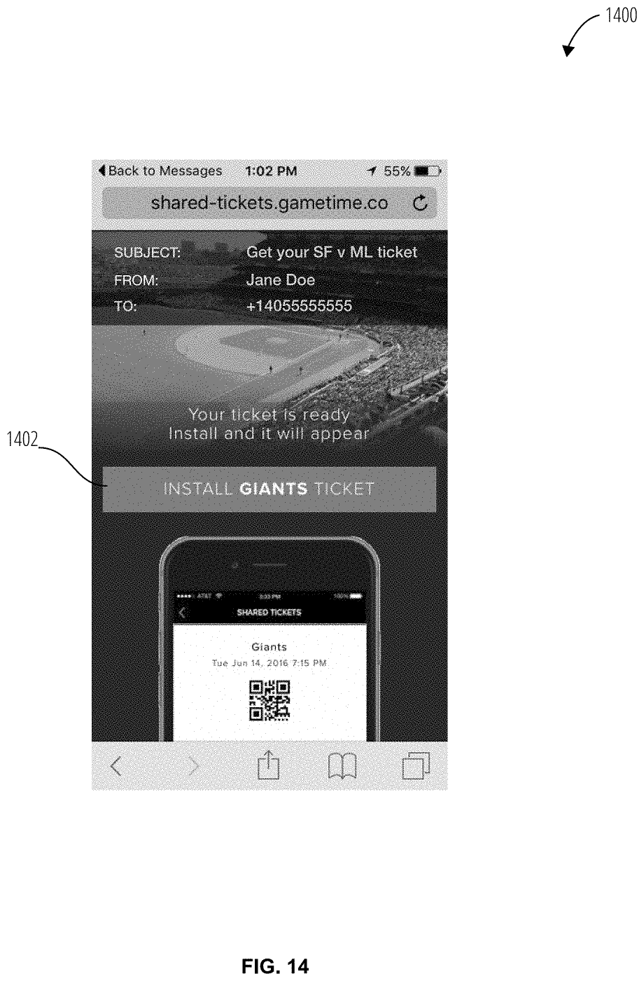

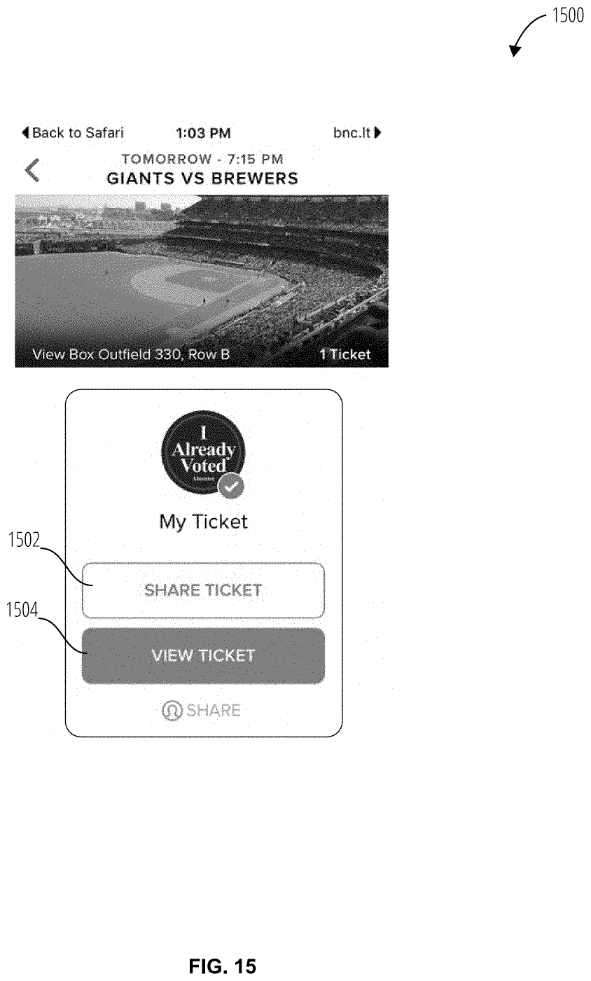

FIGS. 13-15 illustrate embodiments of a user interface displaying the installation and ticket assignment process as viewed on the client device by the selected contact entry. FIG. 13 illustrates an embodiment of user interface 1300 displaying an electronic ticket notification received by the selected contact entry. FIG. 14 illustrates an embodiment of a user interface 1400 displaying a ticket installation option for the selected contact entry. FIG. 15 illustrates an embodiment of a user interface 1500 displaying ticket assignment to the selected contact following ticket installation.

Referring to FIG. 13, the user interface 1300 comprises an electronic ticket notification 1302, a ticket install notification response 1304, and a user interface activator 1306. The electronic ticket notification 1302 is received by the second client device in response to an electronic ticket sharing interface associating the second client device with a selected contact entry. The electronic ticket notification 1302 may comprise the user interface activator 1306. The ticket install notification response 1304 is received by the second client device in response to the shared ticket being associated with a user account in the electronic ticket assignment controlled memory data structure. the ticket install notification response 1304 may comprise a user interface activator 1306. The user interface activator 1306 operates the second client device to alter the user interface 1300 to display the shared ticket.

Referring to FIG. 14, the user interface 1400 comprises a ticket installation activator 1402. The ticket installation activator 1402 receives an input and, in response, alters the user interface 1400 to install the ticket on the second client device. A ticket install notification may be sent to the electronic ticket assignment controlled memory data structure upon selection of the ticket installation activator 1402.

Referring to FIG. 15, the user interface 1500 comprises an electronic ticket sharing interface activator 1502 and a ticket view activator 1504. The electronic ticket sharing interface activator 1502 receives an input and, in response, alters the user interface 1500 to display the electronic ticket sharing interface. The ticket view activator 1504 receives an input and, in response, alters the user interface 1500 to display the ticket.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Programmable device” in this context refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Software” in this context refers to logic implemented as processor-executable instructions in a machine memory (e.g. read/write volatile or nonvolatile memory or media).

“Application interface” in this context refers to is a set of subroutine definitions, protocols, and tools for building application software and may be a set of clearly defined methods of communication between various software components.

“Contact entry” in this context refers to a signal associated with an entity, such as, a person, corporation, etc. comprising information regarding said entity.

“Existing user account” in this context refers to a user account associated with the electronic ticket assignment controlled memory structure created prior to association of the at least one electronic ticket.

“New user account” in this context refers to a user account associated with the electronic ticket assignment controlled memory structure created in response to association of the at least one electronic ticket.

“Stored contacts” in this context refers to a list, group, or association of contact entities associated with a user account.

“Ticket” in this context refers to a digital file or files conveying access rights to an event.

“Ticket install notification” in this context refers to a signal sent by a second client device in response to an electronic ticket being received at an application interface of the second client device, the receipt occurring directly from the first client device or in response to a user interaction with a user interface on the second client device, the signal comprising information regarding the second client device, such as an existing user account.

“User interface” in this context refers to is a type of user interface that allows users to interact with electronic devices through graphical icons and visual indicators such as secondary notation, instead of text-based user interfaces, typed command labels or text navigation. The user interface is utilized for an interaction between the user and the apparatus or device, whereas the application interface determines communication between two software components.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Those skilled in the art will recognize that it is common within the art to describe devices or processes in the fashion set forth herein, and thereafter use standard engineering practices to integrate such described devices or processes into larger systems. At least a portion of the devices or processes described herein can be integrated into a network processing system via a reasonable amount of experimentation. Various embodiments are described herein and presented by way of example and not limitation.

Those having skill in the art will appreciate that there are various logic implementations by which processes and/or systems described herein can be effected (e.g., hardware, software, or firmware), and that the preferred vehicle will vary with the context in which the processes are deployed. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

The foregoing detailed description has set forth various embodiments of the devices or processes via the use of block diagrams, flowcharts, or examples. Insofar as such block diagrams, flowcharts, or examples contain one or more functions or operations, it will be understood as notorious by those within the art that each function or operation within such block diagrams, flowcharts, or examples can be implemented, individually or collectively, by a wide range of hardware, software, firmware, or virtually any combination thereof. Portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more processing devices (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually or collectively, by a wide range of hardware, software, firmware, or any combination thereof can be viewed as being composed of various types of circuitry.

What is claimed is:

1. A mobile communication apparatus comprising:
an antenna;
a processor; and
a memory storing instructions that, when executed by the processor, configure the apparatus to:
receive at least one electronic ticket from an application interface to an electronic ticket vending system in response to an electronic ticket purchasing request applied to the electronic ticket vending system from a user account associated with the application interface;
operate default sharing logic to:
transfer the at least one electronic ticket from the application interface to a user interface; and
display an electronic ticket sharing interface to select a contact entry from stored contacts in the memory;
transmit an electronic ticket notification over the antenna to a network interface to a second client device in response to detecting through the electronic ticket sharing interface a selected contact entry from the stored contacts, the second client device associated with the selected contact entry in the stored contacts;
transmit a ticket install notification to an electronic ticket assignment controlled memory data structure to associate the at least one electronic ticket with the second client device;
transmit an electronic ticket reclamation notification by way of the network interface to the second client device in response to detecting an electronic ticket reclamation control through the electronic ticket sharing interface;
de-associate the at least one electronic ticket with the second client device in response to the electronic ticket reclamation notification;
receive at least two electronic tickets comprising a first electronic ticket and a second electronic ticket received from the electronic ticket vending system for the user account associated with the application interface on the electronic ticket vending system;
further operate the default sharing logic to:
associate the first ticket of the at least two electronic tickets to the user account in the electronic ticket assignment controlled memory data structure;
receive, at the user interface, the second electronic ticket of the at least two electronic tickets from the application interface to the electronic ticket vending system; and
display the electronic ticket sharing interface to select a contact entry from the stored contacts in the memory for the at least one other electronic ticket.

2. The mobile communication apparatus of claim 1, wherein transmission of the electronic ticket notification to the second client device is controlled by contact information associated with the selected contact entry.

3. The mobile communication apparatus of claim 1, wherein the at least one electronic ticket is associated to the second client device through an existing user account associated with the electronic ticket assignment controlled memory data structure.

4. The mobile communication apparatus of claim 1, wherein the at least one electronic ticket is associated to the second client device through a new user account created in the electronic ticket assignment controlled memory data structure.

5. A method of default sharing an electronic ticket purchase comprises:
a first client device receiving at least one electronic ticket from an application interface to an electronic ticket vending system in response to an electronic ticket purchasing request applied to the electronic ticket vending system from a user account associated with the application interface;
operating default sharing logic to:
transfer the at least one electronic ticket from the application interface to a user interface; and
display an electronic ticket sharing interface to select a contact entry from stored contacts in a memory of the first client device;
transmitting an electronic ticket notification by way of a network interface to a second client device in response to detecting through the electronic ticket sharing interface a selected contact entry from the stored contacts, the second client device associated with the selected contact entry in the stored contacts;
transmitting a ticket install notification to an electronic ticket assignment controlled memory data structure to associate the at least one electronic ticket with the second client device;
transmitting an electronic ticket reclamation notification by way of the network interface to the second client device in response to detecting an electronic ticket reclamation control through the electronic ticket sharing interface; and
de-associating the at least one electronic ticket with the second client device in response to the electronic ticket reclamation notification;
receiving at least two electronic tickets comprising a first electronic ticket and a second electronic ticket received from the electronic ticket vending system for the user account associated with the application interface to the electronic ticket vending system;
further operating the default sharing logic to:
associate the first electronic ticket of the at least two electronic tickets to the user account in the electronic ticket assignment controlled memory data structure;
receive, at the user interface, the second electronic ticket of the at least two electronic tickets from the application interface to the electronic ticket vending system; and
display the electronic ticket sharing interface to select a contact entry from the stored contacts in the memory for the second electronic ticket.

6. The method of claim 5, wherein transmission of the electronic ticket notification to the second client device is controlled by contact information associated with the selected contact entry.

7. The method of claim 5, wherein the at least one electronic ticket is associated to the second client device through an existing user account in the electronic ticket assignment controlled memory data structure.

8. The method of claim 5, wherein the at least one electronic ticket is associated to the second client device through a new user account created in the electronic ticket assignment controlled memory data structure.

9. A method of default sharing an electronic ticket purchase comprises:
receiving at least one electronic ticket from an electronic ticket vending system at an application interface in response to receiving an electronic ticket purchasing request from a user account associated with the application interface on the electronic ticket vending system;
operating default sharing logic to:
receive the at least one electronic ticket from the application interface at a user interface;
display an electronic ticket sharing interface to select a contact entry from stored contacts in memory to for the at least one electronic ticket;
transmitting an electronic ticket notification by way of a network interface to a second client device in response to detecting a selected contact entry through the electronic ticket sharing interface;
transmit a ticket install notification to an electronic ticket assignment controlled memory data structure to associate the at least one electronic ticket with the second client device in response to installation of the at least one electronic ticket on the second client device;
receive at least two electronic tickets from the electronic ticket vending system at the application interface in response to receiving the electronic ticket purchasing request from the user account associated with the application interface on the electronic ticket vending system;
further operating the default sharing logic to:
associate a first electronic ticket of the at least two electronic tickets to the user account in the electronic ticket assignment controlled memory data structure;
receive a second electronic ticket of the at least two electronic tickets from the application interface at the user interface; and
display the electronic ticket sharing interface to select the contact entry from the stored contacts in the memory for the second electronic ticket; and
transmit the ticket install notification to the electronic ticket assignment controlled memory data structure to associate the second electronic ticket with the second client device in response to installation of the second electronic ticket on the second client device.

10. The method of claim 9, further comprising:
transmitting an electronic ticket reclamation notification by way of the network interface to the second client device in response to detecting an electronic ticket reclamation control through the electronic ticket sharing interface; and
de-associating the at least one electronic ticket with the second client device in response to the electronic ticket reclamation notification.

11. The method of claim 9, wherein transmission of the electronic ticket notification to the second client device is controlled by contact information associated with the selected contact entry.

12. The method of claim 9, wherein the at least one electronic ticket is associated to the second client device through an existing user account in the electronic ticket assignment controlled memory data structure.

13. The method of claim 9, wherein the at least one electronic ticket is associated to the second client device through a new user account created in the electronic ticket assignment controlled memory data structure.
